(19) United States
(12) Patent Application Publication
(10) Pub. No.: US 2025/0307105 A1
(43) Pub. Date: Oct. 2, 2025

(54) AUTHORIZATION-BASED DATA COLLECTION FOR MONITORED SERVICE INFRASTRUCTURE

(71) Applicant: BMC Software, Inc., Houston, TX (US)

(72) Inventors: Vijay Vasant Bhosale, Pune (IN); Pankaj Prakash Rao, Pune (IN); Geert De Peuter, Turnhout (BE); Rakesh Tiwari, Pune (IN)

(21) Appl. No.: 18/634,853

(22) Filed: Apr. 12, 2024

(30) Foreign Application Priority Data
Mar. 29, 2024 (IN) 202441025804

(51) Int. Cl. G06F 11/34; G06F 21/60

(52) U.S. Cl. CPC G06F 11/3433; G06F 21/604

(57) ABSTRACT

Described techniques implement a bottom-up approach to implementing and scaling a plurality of deployed monitoring agents in a cluster of agents. Each of a plurality of monitoring agents may discover system resources to be monitored, and each monitoring agent may determine its capability, if any, of collecting related monitoring data. Each monitoring agent may then request permission or authorization to commence related monitoring. Centralized management may be provided that provides authorization or denial decisions to each deployed agent that requests such authorization to collect and report on specific instances of monitored entities. Accordingly, centralized decision making may be provided that does not require centralized, top-down load balancing.

### CROSS-REFERENCE TO RELATED APPLICATION

This application claims priority to IN Provisional Application No. 202441025804, filed on Mar. 29, 2024 and entitled “AUTHORIZATION-BASED DATA COLLECTION FOR MONITORED SERVICE INFRASTRUCTURE,” the disclosure of which is hereby incorporated by reference in its entirety.

### TECHNICAL FIELD

This description relates to system monitoring.

### BACKGROUND

Monitoring systems exist that enable analysis and troubleshooting in complex infrastructure environments by monitoring the services of an organization, including software and infrastructure. Such monitoring systems may provide monitoring through collection of performance and/or capability metrics and may provide event management capabilities.

For example, some monitoring systems are designed to ingest events and metrics data using monitoring agents. Systems, software, and other infrastructure being monitored may become larger and more complex over time, so that a number of entities (and aspects thereof that require monitoring) may increase exponentially and unpredictably. For example, in some scenarios a single monitoring agent may be configured to monitor multiple entities and/or parameters, so that as the number of entities and/or parameters grows, the monitoring agent also grows. In other scenarios, a single environment may be monitored by multiple monitoring agents. For example, a container-based environment may include over 100,000 entities that have 10-15 parameters each to be monitored.

In either of the above types of scenarios, more and more resources must be dedicated (either to a single monitoring agent or by increasing a number of deployed monitoring agents), or a lag in collecting and reporting monitored data will develop. Such lags may lead to a further cascading effect with respect to an identification of any problem that occurs or remediation thereof, which may result in downtime for a provided service.

Such difficulties are exacerbated in dynamic environments, in which monitored resources may exhibit need-based growth or reduction. In such cases, manual distribution of monitoring load becomes an infeasible task for operators, who may not be aware of scenarios and timings of when and how to distribute the load. Also, in such environments, in general, increasing the resources would ideally occur uniformly or proportionally across the environment(s). Thus, it is difficult to distribute a monitoring load across multiple agents.

### SUMMARY

According to one general aspect, a computer program product may be tangibly embodied on a non-transitory computer-readable storage medium and may include instructions. When executed by at least one computing device, the instructions may be configured to cause the at least one computing device to receive a first authorization request from a first monitoring agent for first parameter collection for a first discovered instance within a monitored system and receive a second authorization request from the first monitoring agent for second parameter collection for a second discovered instance within the monitored system. When executed by at least one computing device, the instructions may be configured to cause the at least one computing device to receive a third authorization request from a second monitoring agent for the first parameter collection for the first discovered instance within the monitored system, and receive a fourth authorization request from the second monitoring agent for the second parameter collection for the second discovered instance within the monitored system. When executed by at least one computing device, the instructions may be configured to cause the at least one computing device to approve the first authorization request to authorize the first monitoring agent to proceed with the first parameter collection for the first discovered instance, and approve the fourth authorization request to authorize the second monitoring agent to proceed with the second parameter collection for the second discovered instance.

According to other general aspects, a computer-implemented method may perform the instructions of the computer program product. According to other general aspects, a system, such as a mainframe system or a distributed server system, may include at least one memory, including instructions, and at least one processor that is operably coupled to the at least one memory and that is arranged and configured to execute instructions that, when executed, cause the at least one processor to perform the instructions of the computer program product and/or the operations of the computer-implemented method.

The details of one or more implementations are set forth in the accompanying drawings and the description below. Other features will be apparent from the description and drawings, and from the claims.

### BRIEF DESCRIPTION OF THE DRAWINGS

FIG. 1 is a block diagram of a monitoring system with authorization-based data collection.

FIG. 2 is a flowchart illustrating example operations of the monitoring system of FIG. 1.

FIG. 3 is a flowchart illustrating more detailed example implementation aspects of the system of FIG. 1.

FIG. 4 is a block diagram illustrating more detailed operations of example monitoring agents in conjunction with an authorization manager.

FIG. 5A is a first timing diagram illustrating an example implementation.

FIG. 5B is a second timing diagram illustrating an example implementation.

FIG. 6 is an example hierarchy that may be collected and constructed for instance authorization as described herein.

FIG. 7 is a block diagram illustrating an alternate example implementation of the system of FIG. 1.

### DETAILED DESCRIPTION

Described systems and techniques provide adaptive, scalable, dynamic monitoring of system resources, in a manner that optimizes monitoring resources and provides fast, reliable collection of system parameters. Moreover, the preceding and additional features and functions are provided in an automated manner that minimizes a need for administrative input, oversight, or other involvement.

As referenced above, many existing monitoring systems deploy monitoring agents in local or remote systems, and such monitoring agents are configured to collect data regarding various system resources, including, e.g., hardware, software, and related infrastructure elements. The monitoring agents themselves typically utilize some degree of system resources to provide their intended functions. As a result, it is possible for such monitoring agents to be overloaded or inefficient with respect to monitoring tasks to be performed within an available amount of time and using available resources.

For example, when a conventional monitoring agent is tasked with monitoring a particular remote system, it may occur that a workload of the remote system increases over time as additional resources are deployed within the remote system and/or as additional demands are placed on the remote system. It may be possible to increase a reporting capacity of the monitoring agent, but doing so may consume excessive quantities of processing and/or memory resources of the remote system. Otherwise, if the monitoring agent is not provided with sufficient resources, then the monitoring agent may experience an unacceptable degree of lag or latency in reporting collected monitoring data.

Similarly, in other examples, it may occur in conventional systems that a plurality of monitoring agents is deployed within one or more remote systems to be monitored. In such scenarios, again, it may occur that the remote system(s) grows over time so that a demand placed on the monitoring agents also grows. Conventional monitoring systems are not capable of scaling deployed monitoring agents in an acceptable or sufficient manner. For example, multiple monitoring agents deployed with respect to a single remote system may provide overlapping, and therefore wasteful, coverage of the remote system resources, or may inadvertently omit data collection with respect to some aspect(s) of the remote system.

Further, even if a central manager is provided to oversee the deployed monitoring agents, the overhead associated with managing the above-referenced constraints may reduce or eliminate the desired advantages. Moreover, some such conventional central managers may define a single point of failure in the monitoring system that may require unacceptable levels of downtime in the event of any failure of the conventional central manager.

In contrast, described techniques implement a bottom-up approach to implementing and scaling a plurality of deployed monitoring agents. For example, each of a plurality of monitoring agents may discover system resources to be monitored, and each monitoring agent may determine its capability, if any, of collecting related monitoring data. Each monitoring agent may then request permission or authorization to commence related monitoring.

Centralized management may be provided that provides authorization or denial decisions to each deployed agent that requests such authorization to collect and report on specific instances of monitored entities. Accordingly, centralized decision making may be provided that does not require centralized, top-down load balancing.

As a result, monitoring decisions may be made quickly and efficiently, while distributing monitoring duties effectively among available monitoring agents. Failure of a given monitoring agent may be compensated by re-distributing the data collection load among remaining monitoring agents. Similarly, growth in monitored resources may be managed simply by deploying one or more additional agents within the monitored environment, whereupon the monitoring load may again be distributed to make best use of the total number of monitoring agents.

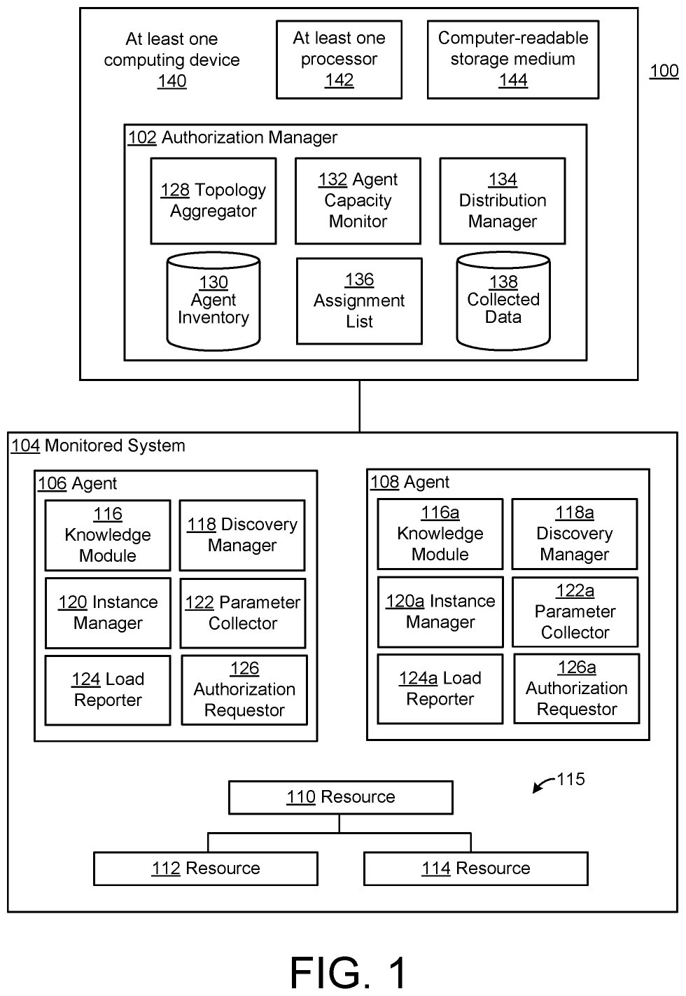

FIG. 1 is a block diagram of a monitoring system 100 with authorization-based data collection. In FIG. 1, an authorization manager 102 may be configured to interact with a monitored system 104 to deploy and manage a plurality of monitoring agents, represented in FIG. 1 by an agent 106 and an agent 108. As further illustrated in FIG. 1, the monitored system 104 may include a plurality of monitored resources that are arranged and configured in the context of one or more network topologies, represented in the simplified example of FIG. 1 by a topology 115 in which a resource 110 is connected as a parent node to a resource 112 child node and to a resource 114 child node.

In FIG. 1, the authorization manager 102 provides a centralized point of management for the agents 106, 108, while the agents 106, 108 are responsible for, e.g., discovering aspects of the topology 115 and requesting authorization from the authorization manager 102 to proceed with monitoring activities. The authorization manager 102 may thus provide, e.g., a binary yes or no decision for each agent monitoring request to establish and maintain a distributed monitoring load across and among the agents 106, 108.

As referenced above, and described in more detail below, real-time monitoring and analysis of infrastructure, applications, or other entities represented by the topology 115 utilize metrics collected from each resource. For example, in conventional systems, entities for which the metrics are to be collected may be provided to a monitoring agent, which may then collect and report metrics data.

For example, in existing systems, a central manager might assign the resource 110 to the agent 106 and the resources 112, 114 to the agent 108. In additional or alternative examples, multiple agents may be required to share a common or overlay namespace in order to collaborate in data collection jobs. For example, a central manager may control a master agent, and the master agent and a set of slave agents may then share a namespace, with each agent handling an assigned portion of a metric collection process for an underlying set of resources.

These and other agent-configuration aspects are generally static, and as the topology 115 grows and new resources are added or removed, load rebalancing and agent configuration may be required to be performed manually. Such rebalancing and configuration efforts may be resource intensive, and, if not performed promptly and sufficiently, will impact the resource utilization of agents collecting metrics and thereby introduce lag or missing data points.

In contrast, as referenced above and described in more detail below, in FIG. 1, each of the agents 106, 108 may be responsible for discovering some or all of the resources 110, 112, 114 of the topology 115. Further, each of the agents 106, 108 may request authorization to commence or continue monitoring some or all of the resources 110, 112, 114 of the topology 115. By providing a yes or no authorization in response to each such authorization request, the authorization manager 102 may maintain a balanced monitoring load across a plurality of agents represented by the agents 106, 108.

Moreover, as the topology 115 grows, new agents may be added to the monitored system 104 and may simply commence performing the same types of discovery and authorization requests just described for the agents 106, 108. Then, without requiring any configuration or manual rebalancing of the various monitoring agents, the authorization manager 102 may effectively redistribute a monitoring load simply by issuing the types of yes or no authorization decisions described above. Similarly, intentional or unintentional (e.g., failure) of an agent may be automatically handled, as well, since remaining agents will continue to discover the topology 115 and request authorization to monitor resources 110, 112, 114 thereof.

In FIG. 1, the monitored system 104 should be understood to represent virtually any computer or network system in which resources represented by the resources 110, 112, 114 may be deployed. For example, the monitored system 104 may represent a virtualized environment, a cloud environment, or a container-based environment.

The resources 110, 112, 114 may thus represent any hardware, software, or network entity for which metrics may be collected. Each such entity may be characterized by one or more characteristics, attributes, or other parameters. Such parameters may themselves be associated with further metrics to be monitored. For example, the resource 114 may represent an entity such as a file system, so that associated parameters may include, e.g., a file system capacity and file system free space, and current values for these parameters may be collected and reported by a designated one of the agents 106, 108.

Thus, collected metrics may include performance metrics characterizing a performance of an underlying resource. Additionally, or alternatively, such metrics may include current characteristics or aspects of an underlying resource, which may change over time.

For example, in some embodiments the monitored system 104 may represent any computing environment of an enterprise or organization conducting network-based IT transactions or interactions. The monitored system 104, however, is not limited to such environments. For example, the monitored system 104 may include many types of network environments, such as network administration of a private network of an enterprise.

The monitored system 104 may also represent scenarios in which sensors, such as internet of things devices (IoT) are used to monitor environmental conditions and report on corresponding status information (e.g., with respect to patients in a healthcare setting, working conditions of manufacturing equipment or other types of machinery in many other industrial settings (including the oil, gas, or energy industry), or working conditions of banking equipment, such as automated transaction machines (ATMs)). In some cases, the monitored system 104 may include, or reference, an individual IT component, such as a laptop or desktop computer or a server. In some cases, the monitored system 104 may include, or reference, a mainframe computing environment.

As the monitored system 104 represents the above and other computing environments, the resources 110, 112, 114 may be understood to represent a correspondingly broad representation of individual entities that may exist and that may be monitored within such computing environments. Consequently, examples of the resources 110, 112, 114 are not set forth in great detail herein, except to the extent that specific examples are provided that may be helpful in understanding operations of the authorization manager 102 and of the monitoring agents 106, 108. By way of non-limiting example, it will be appreciated that, in addition to the file system example provided above, the resources 110, 112, 114 may represent virtual machines or portions thereof, databases or database systems, various business services, and many other types of infrastructure components.

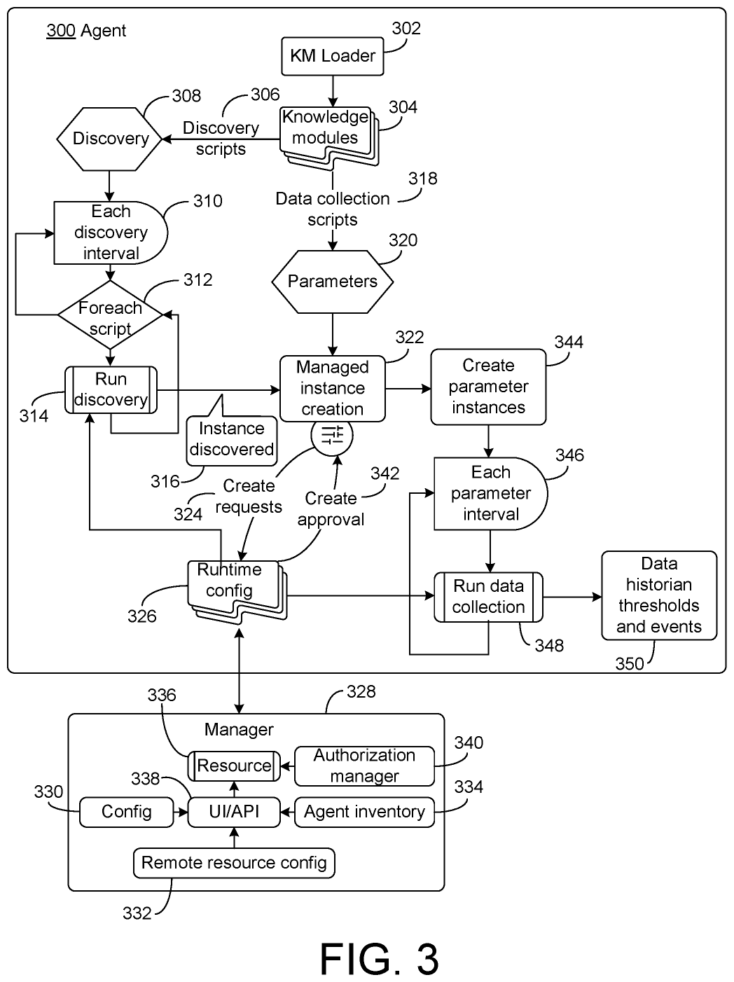

In FIG. 1, the agent 106 is illustrated as including a knowledge module 116, which may represent one or more modules and associated scripts or other code characterizing and enabling desired operations of the agent 106. As described in more detail below with respect to FIG. 3, the knowledge module 116 may obtain such information, as well as code for loading related scripts and other code at the agent 106, from the authorization manager 102 or other available source.

A discovery manager 118 may utilize information from the knowledge module 116 to govern discovery operations with respect to the topology 115. For example, discovery operations may be characterized with respect to a frequency with which each one of one or more discovery scripts is run within the environment of the monitored system 104.

In the present description, the various resources 110, 112, 114 of the topology 115 may each represent an individual entity of an underlying type of resource, where such entities may be created or deleted as needed by an operator of the monitored system 104. For example, a template for a virtual machine (VM) may exist within the monitored system 104, and multiple VM entities may be created therefrom. Similar comments apply to databases, file systems, and other types of available resources.

An instance manager 120 may utilize information from the knowledge module 116 to determine data to be collected from each resource entity discovered by the discovery manager 118, as well as how often such data collection should be performed. For example, for the case of a file system entity, the instance manager 120 may specify that a quantity of free space of the file system be collected at a defined interval. The instance manager 120 may thus be configured to generate an instance for a corresponding entity of the topology 115.

A parameter collector 122 may thus be configured to collect specified parameter(s) from each defined instance of each discovered resource or entity. As already referenced above, a number of parameters and a frequency of collection of each parameter may vary based on each underlying resource instance and may be dictated by contents of the knowledge module 116, as well as perhaps being dictated by system and/or network conditions and other factors.

A load reporter 124 may be configured to determine a current load of the agent 106 with respect to assigned or available resources of the agent 106, as well as a projected future load that will be associated with the parameter and/or data collection for a given instance. For example, the agent 106 may be provided with sufficient processor, memory, and other resources of the monitored system 104 to collect a maximum number and frequency of parameters and/or associated resource instances. Therefore, at any given time, the agent 106 may be considered to be operating at a percentage of its maximum collecting and/or reporting capacity. The load reporter 124 may thus report a current load of the agent 106 using any suitable metric(s), such as a current capacity percentage being used, an absolute number of instances and/or parameters being monitored, and/or a lag or latency experienced by the agent 106 in collecting and/or reporting parameters. Similarly, the load reporter 124 may report a projected future load in corresponding terms (e.g., an additional percent capacity projected to be consumed or an incremental lag or latency likely to be imparted by beginning the identified parameter collection).

An authorization requestor 126 may be configured to request the type of parameter collection authorization referenced above from the authorization manager 102. For example, as just described, the discovery manager 118 may collect specified information characterizing the topology 115 and the instance manager 120 may determine a number of instances needed for monitoring (along with specified parameter collection types and intervals). Then, prior to commencing any actual parameter collection by the parameter collector 122, the authorization requestor 126 may request authorization from the authorization manager 102 to proceed with parameter collection for each discovered resource entity.

For example, the instance manager 120 may discover the resources 110, 112, 114 as resource entities and may generate an authorization request(s) that specifies these resource entities and associated parameter collection requirements, as well as a current load of the agent 106 as determined from the load reporter 124. As referenced above, and described in more detail, below, the authorization manager 102 may evaluate the authorization request(s) and return a yes or no (e.g., proceed or don't proceed) decision with respect to instance creation and parameter collection for each specified resource entity. For example, the authorization manager 102 may specify that parameter collection should proceed with respect to an instance for the resource 112 but not with respect to the resources 110, 114 (which may be monitored, e.g., by the agent 108). Upon receipt of such authorization, the agent 106 through the parameter collector 122, may proceed with the already-determined schedule of collecting identified parameters.

As shown in FIG. 1, the agent 108 may be constructed in a similar or identical manner to the agent 106. That is, as shown, the agent 108 includes a number of modules or components corresponding to the above-described aspects of the agent 106. In particular, the agent 108 includes a knowledge module 116a, a discover manger 118a, an instance manager 120a, a parameter collector 122a, a load reporter 124a, and an authorization requestor 126a.

Therefore, the agent 108 may execute the same or similar operations as just described with respect to the agent 106. That is, the discovery manager 118a may discover the resources 110, 112, 114 of the topology 115 and the instance manager 120a may identify specific resources entities to be monitored by corresponding instances, based on content of the knowledge module 116a. Prior to commencement of resulting parameter collection by the parameter collector 122a, the authorization requestor 126a may request authorization thereof from the authorization manager 102, including specifying a current load of the agent 108 based on an output of the load reporter 124a.

In the example of FIG. 1, both the discovery manager 118 and the discovery manager 118a may perform the same or similar discovery operations with respect to the topology 115. Authorization requests generated by the authorization requestors 126, 126a may include some or all of the information discovered with respect to the topology 115, in conjunction with the instance information from the instance managers 120, 120a and the load report from the load reporters 124, 124a.

The authorization manager 102 may include a topology aggregator 128 that is configured to receive such discovered topology information from the agents 106, 108 and construct a corresponding topology model(s). In the simplified example of FIG. 1, the agents 106, 108 are described as discovering and reporting all of the topology 115. In other examples, however, an agent or subset of agents may discover only a portion of an available topology. For example, some agents may have defined privileges with respect to discovering and/or monitoring defined types or categories of resources, which are not discovered and/or monitored by other types or classes of agents. In other examples, connection difficulties may cause an agent to fail to discover some portion of the topology 115. In such cases, the topology aggregator 128 may obtain a holistic view of an entire topology 115 by aggregating discovery reports across all classes of agents, but agents that are not privileged or otherwise able to monitor a particular resource 110, 112, 114 will not be assigned parameter collection duties for that resource.

The authorization manager 102 also includes an agent inventory 130 that specifies all available and deployed or deployable agents, including the agents 106, 108. The agent inventory 130 may specify characteristics of each agent, such as the types of discovery and/or monitoring permissions just referenced. The agent inventory 130 may also specify other parameters of each agent, such as an agent capacity.

An agent capacity monitor 132 may be configured to determine a current capacity of each agent, such as the agents 106, 108, based on content of load reports received from the load reporters 124, 124a. As described, load reports may be received in conjunction with authorization requests, or may be sent separately, e.g., periodically, by the load reporters 124, 124a.

A distribution manager 134 may thus provide or refuse authorization to each agent in response to each authorization request therefrom. For example, the distribution manager 134 may receive authorization requests from each of the agents 106, 108, where each authorization request specifies a corresponding current load of each agent and defines discovered entities and associated requirements for parameter collection (e.g., number, type, and collection frequency). The distribution manager 134 may evaluate each authorization request (e.g., for each specified instance), including comparing each agent load with each corresponding agent capacity as determined by the agent capacity monitor 132, and relative to a projected load imparted by commencing parameter collection for the instance being considered for authorization.

For example, in some scenarios, the load reporters 124, 124a may report to the agent capacity monitor 132 on a defined schedule, which may be separate or independent from the authorization requests. Additionally, or alternatively, load reports may be included with authorization requests, as in some examples above.

The agent capacity monitor 132 may monitor and specify each agent capacity, in absolute and/or relative terms. For example, the monitored system 104 may have many agents deployed therein, and the agent capacity monitor 132 may rank agents from most-to-least available capacity. In some examples, agent capacity may be rated and/or ranked as a function of reporting latency, so that an agent with a larger latency is considered to have less capacity than an agent with a lower latency.

An assignment list 136 may be used to store agents and associated current monitoring and/or instance assignments. For example, the assignment list 136 may include the types of agent rankings just described.

In FIG. 1, the authorization manager 102 is illustrated as including collected data 138, which represents, e.g., parameters collected by the parameter collectors 122, 122a. The collected data 138 may include only a subset of collected parameters, such as when a series of collected parameters are determined to represent an event, such as an anomaly or malfunction. The collected data 138 need not be stored using the authorization manager 102. For example, the collected data 138 may be forwarded to longer term storage by the authorization manager 102 or may be reported directly from each agent 106, 108 to longer term storage.

In FIG. 1, the authorization manager 102 is illustrated as operating on at least one computing device 140, which includes at least one processor 142 and a non-transitory computer-readable storage medium 144. For example, the computer-readable storage medium 144 may store instructions that, when executed by the at least one processor 142, cause the at least one computing device 140 to provide the features and functions of the authorization manager 102 described herein. It will be appreciated that the agents 106, 108 may be implemented using corresponding memory and processing components of computing devices of the monitored system 104, although such elements are not shown separately in FIG. 1 for the sake of brevity and simplicity.

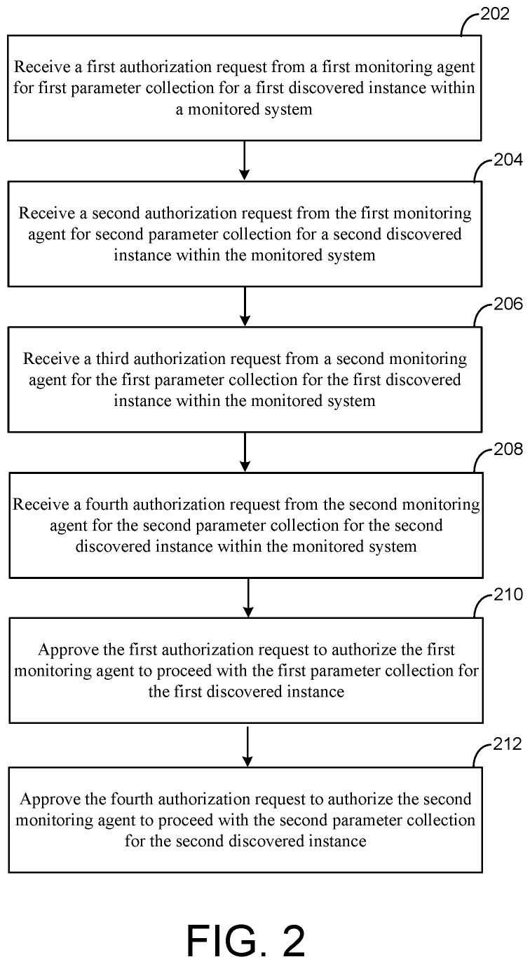

FIG. 2 is a flowchart illustrating example operations of the system of FIG. 1. In the example of FIG. 2, operations are illustrated as separate, sequential operations. In various implementations, however, the illustrated operations may include sub-operations, may be performed in a different order, may include alternative or additional operations, or may omit one or more operations. Further, in all such implementations, included operations may be performed in an iterative, looped, nested, or branched fashion.

In FIG. 2, a first authorization request may be received from a first monitoring agent for first parameter collection for a first discovered instance within a monitored system (202). A second authorization request may be received from the first monitoring agent for second parameter collection for a second discovered instance within the monitored system (204).

For example, the discovery manager 118 of the agent 106, based on contents of the knowledge module 116, may execute a discovery process with respect to the monitored system 104 and may discover the topology 115, including the resources 110, 112, 114. Then, for example, the authorization manager 102 may receive a first authorization request from the agent 106 for first parameter collection for the resource 110 within the monitored system 104, and a second authorization request from the agent 106 for second parameter collection for the resource 112 within the monitored system 104. Not shown separately in FIG. 2, the authorization manager 102 may receive additional authorization requests from the agent 106 for additional parameter collection, e.g., for the resource 114 or other discovered resources.

In the present description, the term instance should be understood to refer to any occurrence or representation of a system resource or entity. That is, an instance may refer to an entity of an underlying system resource, such as a specific VM that is an instance of a VM template. An instance may also be referred to as being created by the instance manager 120, in the sense that the instance manager 120 generates and utilizes a data structure for parameter collection that has a one-to-one mapping with the underlying resource instance. For example, in the example just given, the instance manager 120 (if authorized by the authorization manager 102, as described herein), may construct an instance for use in collecting and transmitting parameter(s) for one or more underlying resources and/or entities.

A third authorization request may be received from a second monitoring agent for the first parameter collection for the first discovered instance within the monitored system (206). A fourth authorization request may be received from the second monitoring agent for the second parameter collection for the second discovered instance within the monitored system (208).

For example, the discovery manager 118a of the agent 108, based on contents of the knowledge module 116a, may execute a discovery process with respect to the monitored system 104 and may discover the topology 115, including the resources 110, 112, 114. Then, for example, the authorization manager 102 may receive the third authorization request from the agent 108 for the same (e.g., first) parameter collection for the resource 110 within the monitored system 104 requested by the first monitoring agent 106, and a fourth authorization request from the agent 108 for the (same) second parameter collection for the resource 112 within the monitored system 104 requested by the first monitoring agent 106. Not shown separately in FIG. 2, the authorization manager 102 may receive additional authorization requests from the agent 108 for additional parameter collection, e.g., for the resource 114 or other discovered resources.

Then, the first authorization request may be approved to authorize the first monitoring agent to proceed with the first parameter collection for the first discovered instance (210), and the fourth authorization request may be approved to authorize the second monitoring agent to proceed with the second parameter collection for the second discovered instance (212). For example, the authorization manager 102 may authorize the agent 106 to proceed with parameter collection with respect to the resource 110 and may authorize the agent 108 to proceed with parameter collection with respect to the resource 112. One of the agents 106, 108, or another available agent (not shown in FIG. 2) that requests authorization may be approved for collecting parameters associated with the resource 114.

Although not illustrated in the simplified example of FIG. 2, each of the agents 106, 108 may also include its current capacity or load, as determined by the load reporters 124, 124a, when sending the various authorization requests. The authorization manager 102 may use one or more distribution algorithms to determine which authorization requests to approve. Various other additional or alternative operations may be implemented with respect to the embodiments of FIGS. 1 and 2, some of which are described and illustrated below with respect to the more detailed example embodiments of FIGS. 3-6.

Thus, FIGS. 1 and 2 illustrate operation of the agents 106, 108 in a cluster mode, in which the agents 106, 108 (and possibly other agents, not shown in FIG. 1) are jointly responsible for discovering and monitoring a common topology 115, based on authorizations from the authorization manager 102. Such cluster mode operations may incur overhead with respect to the otherwise total number of discovery processes performed and associated communications with the authorization manager 102, but yield described advantages, including, e.g., scalability and adaptability with respect to changes in the monitored system 104, reliability in parameter collection, and reduced burden on the authorization manager 102 as a central point of agent management.

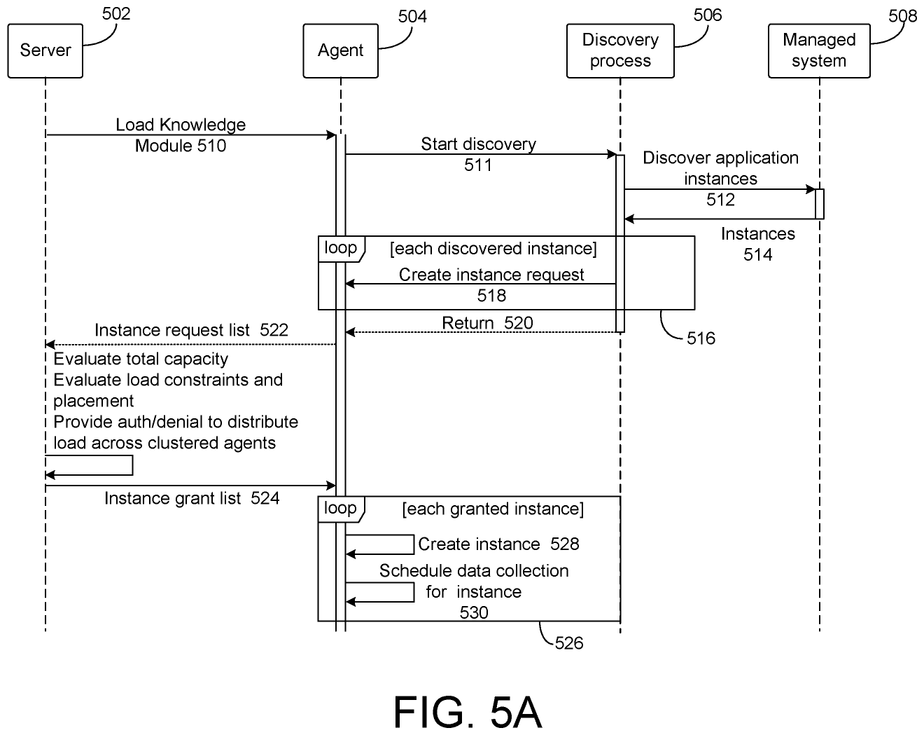

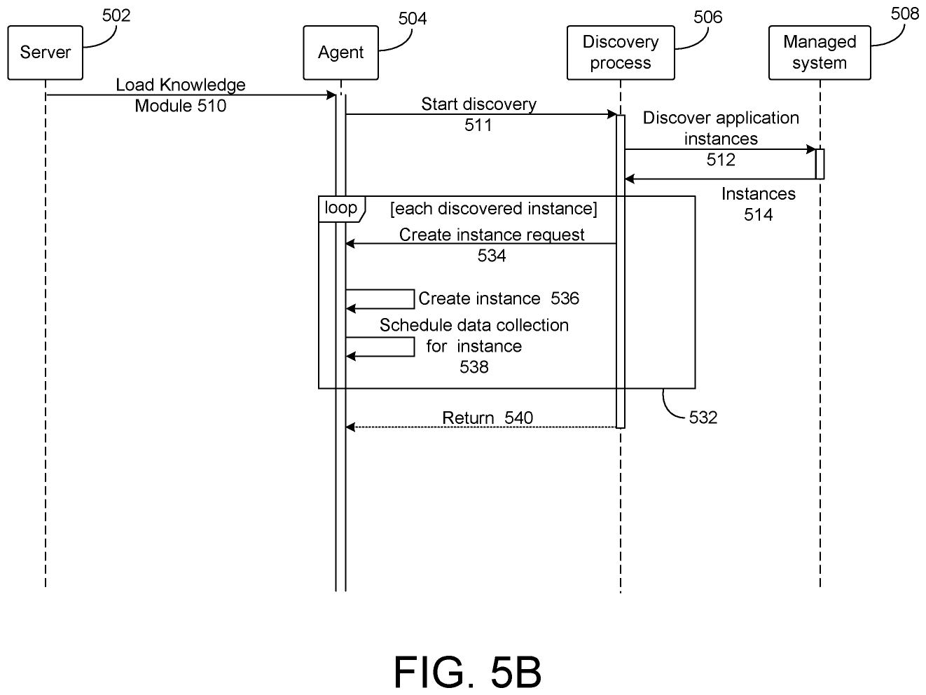

Nonetheless, as described below with respect to FIG. 5B, it is also possible to operate one or either of the agents 106, 108 in a single agent mode and/or in a conventional load-balancing approach. For example, if the topology 115 is sufficiently small, the agent 106 may be deployed on its own to manage monitoring of the topology 115. For example, the agent 106 may be configured to discover the resources 110, 112, 114 of the topology 115 and automatically begin corresponding parameter collection.

As already described with respect to conventional systems, such an approach may initially operate with a reduced overhead compared to the examples of FIGS. 1 and 2, but may ultimately lead, for example, to undesirable levels of growth of the agent 106 and/or associated reporting lags. Therefore, in example implementations, the system 100 of FIG. 1 may be configured to switch, e.g., from an individual agent monitoring mode to a cluster monitoring mode in response to system conditions. For example, in the preceding example, when the agent 106 exhibits a defined level of lag in reporting, then the agent 108 may be deployed to the monitored system 104 and a switch to cluster monitoring mode may be executed.

FIG. 3 is a flowchart illustrating more detailed example implementation aspects of the system of FIG. 1. In FIG. 3, an agent 300 (representing an example of the agent 106 or the agent 108 of FIG. 1) interacts with a manager 328 (representing an example of the authorization manager 102 of FIG. 1).

At the agent 300, a knowledge module (KM) loader 302 loads a plurality of knowledge modules 304. The knowledge modules 304 include one or more discovery scripts 306 that are executed in a discovery process 308. Specifically, at a defined discovery interval 310, and for each script 312, discovery is performed (314) and one or more instances is discovered 316.

The knowledge modules 304 also contain data collection scripts 318, which define parameters 320 to be collected for each type of instance that might be discovered during the above-described discovery process. For example, as in the examples provided above, discovery scripts 306 may cause a first file system instance to be discovered during a first discovery interval, and data collection scripts 318 may define corresponding parameters (e.g., quantity of free space in the file system instance) to be collected. During a second discovery interval, a second file system may be discovered that was created between the first and second discovery intervals, so that the same parameters defined for the first file system may be identified, as well. In another example, a VM created between the first and second discovery intervals may be discovered, and corresponding parameters may be identified, such as a percentage of assigned central processing unit (CPU) resources used by the discovered VM.

Managed instance creation (322) may then proceed with creation of an authorization request(s) 324 to be sent to the manager 328 for authorization to proceed with collection of identified parameters for discovered instance(s). In FIG. 3, a runtime configuration 326 may be configured to receive the authorization requests, as well as to manage the above-described discovery process(es).

As shown, the runtime configuration 326 may be configured to transmit the authorization requests to the manager 328. The manager 328 includes a user interface or API 338 that may represent either a user interface (UI) and/or an application program interface (API) that enables communications with, e.g., users and/or administrators, the agent 300, other agents not shown in FIG. 3, and various other system resources.

A configuration database 330 may be configured to store, e.g., data that may be used by the agent 300, such as the knowledge modules 304. A remote resource configuration 330 may be provided that utilizes the interface 338 to determine, e.g., topology data collected by discovery processes of the agent 300 and other agents, which may be stored in conjunction with resource data 336 representing resources available to, and used by, the agent 300 and other agents. An agent inventory 334 stores available agents and their current capacities and/or loads. Other agent data, such as reporting latencies, or types of parameters being collected, may also be stored using the resource data 336 and/or the agent inventory 334.

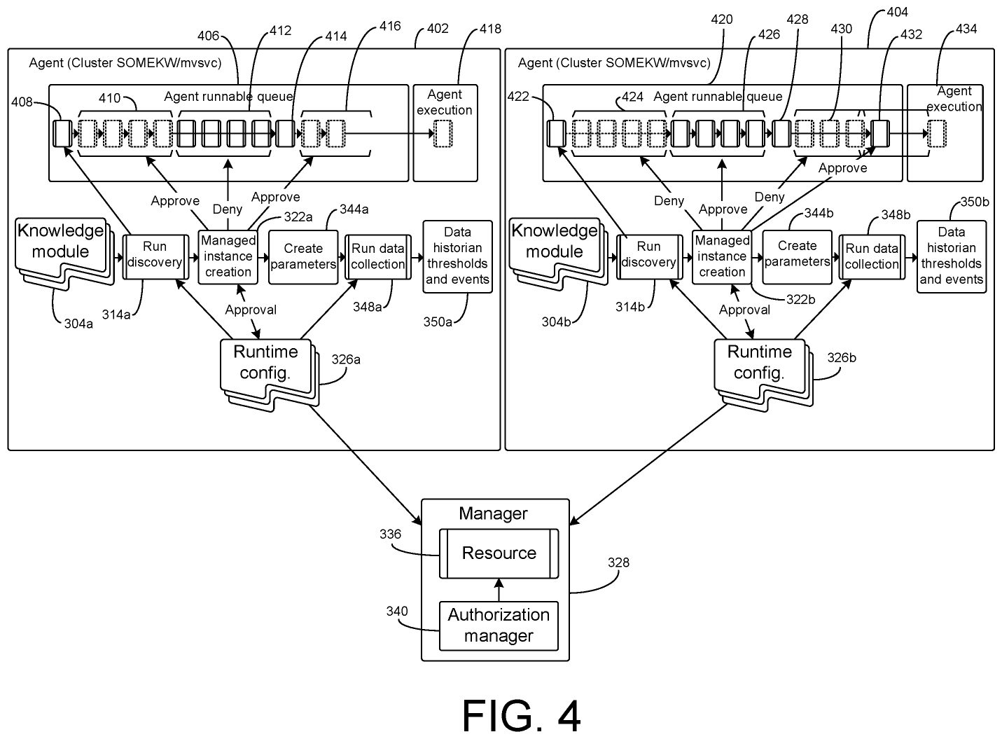

An authorization manager 340 (representing an example of the authorization manager 102 of FIG. 1) may be configured to receive the created authorization requests 324, via the interface 338. As described with respect to FIG. 1, and in further detail below with respect to FIGS. 4, 5A, and 6, the authorization manager 340 may execute a distribution algorithm using the agent inventory 334 and other information from the resource data 336 to determine whether to approve the authorization requests 324 in a manner that distributes a total monitoring load in a desired and/or configured manner across the agent 300 and other agents communicating with the manager 328.

For example, the authorization manager 340 may execute a distribution algorithm in a manner that ensures that only a single agent (e.g., with a highest available capacity of all reporting and/or requesting agents) proceeds with a corresponding requested parameter collection, to avoid redundancy of parameter collection (notwithstanding the designed redundancy of discovery processes with respect to discovering an underlying topology, as described with respect to FIGS. 1 and 2). In other examples, other metrics may be used (e.g., latency instead of, or in addition to, capacity).

Assuming that the agent 300 is approved for the requested authorization in the example of FIG. 3, an approval 342 may thus be passed through the runtime configuration 326 and to the managed instance creation 322. Then, parameter instances may be created 344. For each parameter interval 346, data collection may be run 348 in accordance with the runtime configuration 326 for that type of parameter/collection. At each parameter interval, collected data may be passed to a historian, where baselines are generated, thresholds evaluated, and events generated 350.

Thus, in FIG. 3, and as described herein, discovery processes occur within the single agent 300 and various other reporting agents in a single cluster of agents, so that monitoring loads are distributed using described techniques and without requiring traditional, centrally managed load balancing. In conventional systems, in contrast, and as referenced above, either a single agent may be responsible for an entire topology 115, or two or more agents may share responsibility for a single underlying resource 110, 112, 114 (e.g., may take turns collecting the same parameter data across multiple collection intervals, using a shared namespace). Such conventional approaches are prone to agent overload and are difficult to scale in any feasible, practical manner and without requiring significant manual rebalancing efforts.

FIG. 4 is a block diagram illustrating more detailed operations of the example of FIG. 3. In FIG. 4, a monitoring agent 402 and a monitoring agent 404 both represent examples of agents having the structure and operation of the example agent 300 of FIG. 3, and in communication with the manager 328 of FIG. 3. Therefore, elements having common reference numerals with corresponding elements of FIG. 3 are numbered similarly, including, for the manager 328, resource data 336 and authorization manager 340.

Similarly, agents 402, 404 include various elements and aspects numbered similarly to the agent 300 of FIG. 3, but with a/b designators for distinguishing between the agents 402, 404 relative to the agent 300. That is, as shown, the agent 402 includes runtime configuration 326a, knowledge modules 304a, discovery 314a, managed instance creation 322a, creation of parameters 344a, data collection 348a, and data historian (thresholds and events) 350a. The agent 404 includes runtime configuration 326b, knowledge modules 304b, discovery 314b, managed instance creation 322b, creation of parameters 344b, data collection 348b, and data historian (thresholds and events) 350b.

As described with respect to FIG. 3, at start up, instance discovery runs. In the example of Apache Kafka® software, instance discovery may find hundreds of instances. For each of these instances data collection jobs are created, resulting in potentially thousands of parameters that must be scheduled.

In the example of FIG. 4, the agents 402, 404 are participating in the same collection cluster for a resource type called “SSOMEKW”. The cluster is named “mvsvc” in this example. Both agents 402, 404 may run the same discovery scripts and both agents 402, 404 are likely to discover the same resource instances. As noted above, it is possible that issues such as connectivity losses may cause a failure of one of the agents 402, 404 to discover some resource instances, but the described architecture and discovery approach ensures that all discovered instances will be monitored by at least one agent 402, 404.

In FIG. 4, the agent 402 executes an agent runnable queue 406. Discovery 408 is managed by the discovery process 314a and discovers an instance 410 and an instance 412. Similarly, discovery 414 discovers an instance 416. Managed instance creation 322a executes the above-described communication with the manager 328 to request authorization for parameter collection for the discovered instances 410, 412, 414, 416.

Meanwhile, the agent 404 executes an agent runnable queue 420. Discovery 422 is managed by the discovery process 314b and discovers an instance 424, an instance 426. Similarly, discovery 428 discovers an instance 430 and an instance 432. Managed instance creation (322b) executes the above-described communication with the manager 328 to request authorization for parameter collection for the discovered instances 424, 426, 430, 432.

The manager 328 may thus choose which instances get approved for which agent, while assuring that each discovered instance will be monitored at least once. If one of the agents 402, 404 disappear (e.g., terminates or disconnects), then the manager 328 may update approvals for the remaining agent(s). Unlike with conventional (e.g., transaction-based) systems, it is not essential that this switch happens immediately. For example, even if double data collection happens momentarily, resulting data duplication may be handled downstream. For example, a data historian may ignore double data collections from a secondary source if the first source is still providing data.

As shown, the agent 402 has instances 410 and 416 approved while instance 412 is denied. The agent 404 correspondingly has instances 424 and 430 denied, while instances 426 and 432 are approved. In FIG. 4, the various instances may be understood to include individual parameter collections represented by the individual boxes of each instance that advance through the queues 406, 420, so that, as shown, each parameter collection occurs during an agent execution 418 performed by the agent 402 and during an agent execution 434 performed by the agent 404.

The previous section shows an example approval process. Agents 402, 404 may also include profilers, such as the load reporter 124, 124a of FIG. 1, which allow agents to report to the manager 328 at regular intervals to report a true quantity of resource costs used to run the monitoring workloads for each of the various instances. If the manager 328 determines that the workloads are becoming unbalanced, better placement can be decided using any load balancing algorithm known in the art like the first-fit algorithm (also known as the bin-packing algorithm), or the first-fit decreasing algorithm, in which items are sorted in descending order and then allocated to the agent that is currently the least full.

If workloads are removed, other suitable algorithms may be used. For example, “incremental rebalancing” can be performed in which a new average and least number of changes are calculated to determine instance reassignments.

FIG. 5A is a first timing diagram illustrating an example implementation. FIG. 5A shows resource monitoring in the cluster mode described above with respect to FIG. 4, in which multiple agents monitor available resources.

In FIG. 5A, a server 502 provides central agent management in the manners described herein, including providing authorization management. An agent 504 represents each agent of a cluster of agents, so that a discovery process 506 represents corresponding discovery processes that each such agent performs. A managed system 508 represents an example of the monitored system 104 of FIG. 1.

As shown in FIG. 5A, the agent 504 may initially load one or more knowledge modules from the server 502 (510). Using the scripts and other information contained therein, the agent 504 may commence the discovery process 506 (511). The discovery process 506 is thus able to discover active instances within the managed system 508 (512), where such instances are thus identified and enumerated as part of the discovery process 506 (514). Within a processing loop 516 for each discovered instance, an instance request is created for each discovered instance (518), after which control returns (520) to the agent 504 for transmission of a resulting instance request list (522) to the server 502.

At the server 502, a total agent capacity across available agents is evaluated, relative to load constraints associated with each instance request and placement options for each instance. Accordingly, the server 502 may determine authorizations and denials to be sent to each agent to effectively distribute the monitoring load across the clustered agents in a desired manner. Then, an instance grant list may be sent to the agent 504 (524).

In a loop 526 at the agent 504, for each granted instance request, an instance may be created (528). Data collection for the created instance may thus be scheduled (530).

To improve reliability and reduce dependency on the manager at the server 502, one or more local agent(s) 504 may cache the assignment decisions from the manager. In this way, continuity of monitoring may be maintained in case of any connection problems. Such cashing may also be used to reduce overhead of the cluster-based monitoring procedures described herein.

As described above, and as shown in FIG. 5B, in some scenarios an authorization manager running at the server 502 may determine that there is currently insufficient monitoring load, relative to available resources, to justify or necessitate running the agent 504 in cluster mode. In other words, overhead associated with running in cluster mode may be avoided when not needed.

Therefore, in FIG. 5B, in which the agent 504 is switched to individual agent mode, the processes of loading the knowledge module (510), starting discovery (511), and discovering (512) and reporting instances (514) proceeds as described with respect to FIG. 5A. In FIG. 5B, however, in single agent mode, a loop 532 is executed in which, for each discovered instance, an instance request is created (534) and the agent 504 responds by creating a corresponding instance (536), without a need for any round trip communication with the server 502 for authorization. Instead, data collection for the created instance may be immediately scheduled (538), and the discovery process 506 may return (540) to the agent 504 for commencement of the resulting data collection.

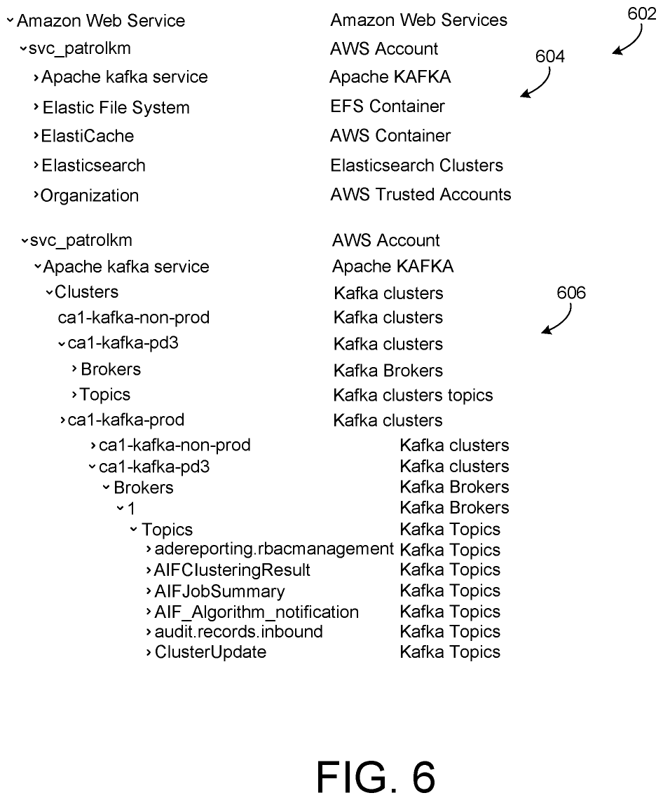

FIG. 6 is an example hierarchy 602 that may be collected and constructed for instance authorization as described herein. FIG. 6 illustrates an example illustrating how a load of instances may be distributed across multiple agents configured in cluster mode discovery. FIG. 6 provides an example of Amazon Web Services knowledge management (AWS KM) running Elastic file and/or search system(s) and service(s), which may include a large number of instances based on, e.g., a number of regions and a number of services being monitored in the environment.

In the hierarchy of FIG. 6, which has an Apache Kafka Service configured, clusters being discovered may be dynamic and may be based on a number of clusters configured in the environment. The Kafka service may store and share data using servers known as brokers, which moderate information according to defined topics. In large AWS environments, a number of instances that may be discovered may be in the hundreds of thousands, thereby potentially adding load and introducing lag in data collection and data streaming in conventional approaches. To resolve such issues, operators may set up groups of agents in the cluster mode, as described herein, e.g., while configuring a monitoring policy.

The resulting configuration may be propagated to the agents in a cluster environment. For example, portion 604 of FIG. 6 illustrates a first agent svc_patrolkm and associated instances, while portion 606 of FIG. 6 illustrates a second agent svc_patrolkm and associated instances.

Each agent may run discovery on the AWS environment of FIG. 6 to determine a list of services in the environment. This list will be sent back to the manager. The manager may identify a total number of instances that could be potentially discovered on these agents and that are configured in cluster mode. If the number of instances is more than the capacity that could be handled by a single agent, then the manager will distribute the creation of instances based on split mechanism or logic. Accordingly, instances created on one agent in cluster for data collection will not also be created on other agent(s). The manager may also provide the list of unique instances that need to be discovered on each agent in the cluster.

A discovery process may be triggered on the agents in a cluster. During single mode operation, an agent may use a call that accepts a list of instances to be created. This call may be overridden when the agent is configured in cluster mode. If in cluster mode, the create instance function may be capable of accepting the list of instances. By doing this, the instances that are created on one node in the cluster will not be created on another node in the cluster.

At a second time, the agents will perform the discovery once again and return the list of new instances discovered in the environment to the manager. In the example, the manager will then allow the creation approval for the agent in cluster node which has the least number of instances.

At a third time, the agent will perform the discovery again and there may be one or more nodes of agent(s) at which instances have been destroyed. Such instances may be sent back to the manager. The manager may then identify a list of instances that were created on each agent in the cluster and send the list of instances to be destroyed on that node of the agent in the cluster. The agent may use a suitable destroy call that, e.g., accepts the list of instances to be destroyed and destroys the instances.

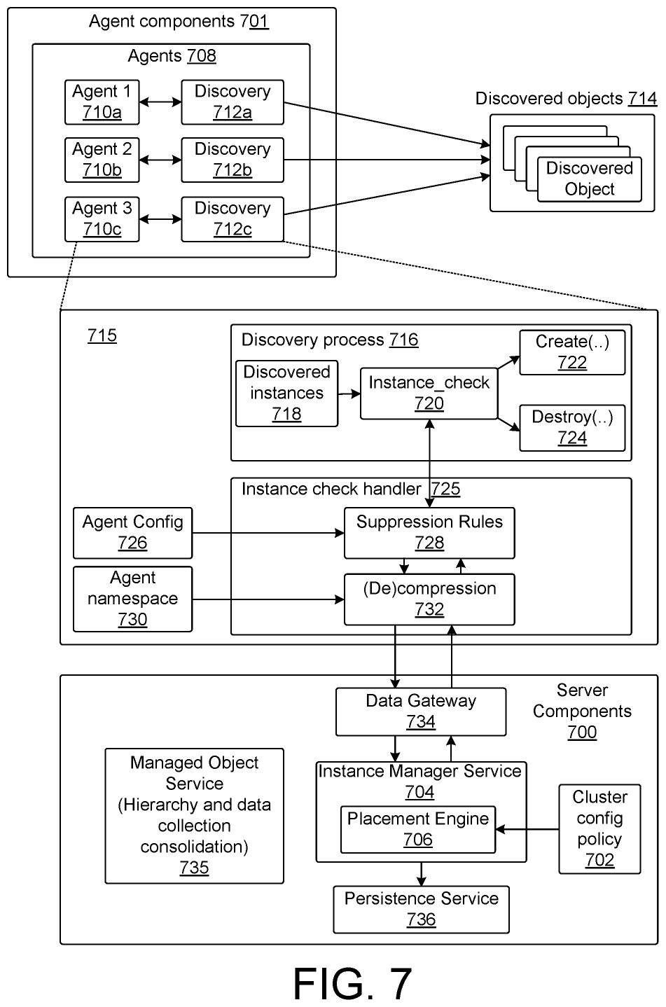

FIG. 7 is a block diagram illustrating an alternate example implementation of the system of FIG. 1. In the example of FIG. 7, server components 700 are used to oversee and implement agent components 701. More specifically, a cluster configuration policy 702 represents a user-configured policy or set of policies for the agent components 701, e.g., one or more policies that will be applied to agents 708 participating in a given cluster.

The agents 708 may thus trigger one or more discovery processes, illustrated in FIG. 7 as agent 710a initiating discovery 712a, agent 710b initiating discovery 712b, and agent 710c initiating discovery 712c. The discovery processes 712a, 712b, 712c proceed to discover a plurality of individual discovered objects 714 for which parameter collection should be performed.

As shown in expanded view 715 for the agent 710c and discovery 712c, each agent executes discovery process 716 in which discovered instances are used to execute an authorization request by supplying the discovered instances 718 to an instance_check call 720. As described above, and shown in more detail in FIG. 7, each such instance check call may result in a response from server components 700 to either create 722 or destroy 724 a corresponding instance for parameter collection. In other words, each agent, such as the agent 710c for the expanded view 715, receives a list of approved and denied instances, such that each of the discovered objects 714 will be monitored by at least one corresponding one of the agents 708.

In the implementation of FIG. 7, prior to transmitting the instance_check call 720 to the server components 700, an instance check handler 725 may filter the prepared list of instances. For example, an agent configuration 726 may be checked for suppression rules 728 defining excluded instances. For example, excluded instances may be defined based on policies of the agent configuration 726 that define or allow either global collection suppression (e.g., on all instances of the cluster of the agents 708) or local collection suppression (e.g., for an individual cluster agent).

Also prior to sending the final, filtered instance request, an agent namespace 730 may be used to execute compression (and decompression upon a return from the server components 700) of the data. For example, any conventional compression tools may be used, such as zip or delta compression techniques.

Upon receipt at a data gateway 734, an instance manager service 704 may proceed to process the authorization request(s), including a list(s) of requested instances for parameter collection. The authorization request list(s) may also contain load metrics of the various agents 708, which may be processed by a placement engine 706.

The instance manager service 704 may query and update instance allocations for all the agents 708 in the cluster, using, e.g., some of the placement algorithms described above, or other suitable algorithms. For example, first-fit, load-balanced, or equal-quantity approaches may be used, as known and/or as referenced herein. Any suitable placement attribute available to the placement engine 706, including load metrics, may be used. A persistence service 736 may store placement results describing which agent has received authorization for which instance and/or parameter collection.

The placement information may then be passed back to each agent via the data gateway 734. For example, a placement decision may be passed as an authorization to an authorized agent for a corresponding instance, while sending a deny for the same instance to all remaining agents.

Some duplication of data and/or parameter collection may initially occur in which two or more agents collect data for a single managed object and/or instance. A managed object service 735 may be configured to resolve such issues and consolidate data and/or parameter collection across the agents 708 as needed, once a suitable topology or other hierarchy is collected to ensure that all discovered objects 714 are being monitored.

Described implementations provide solutions for many different scenarios and contexts. For example, for a single solution monitoring cluster, there may be 1000 machines that must be remotely monitored. A monitoring cluster of five agents may be created to manage this workload. The configuration of those machines may be assigned to the cluster. All machines in the cluster may then discover the same 1000 machines. The instance manager will spread the list across the five agents automatically, using described techniques.

When monitoring requirements for a region span multiple solutions, a regional monitoring cluster may be created to handle all the remote data collections across solutions. For example, the previous five-agent cluster may be extended to a regional fifteen-agent cluster. In that regional cluster, all solutions that must be monitored across these agents may be added. Instead of assigning the configuration to individual agents or individual solution clusters, described techniques may be used to add various monitoring operations (e.g., database, Kafka, or Elastic search, as shown in FIG. 6) to the regional cluster. In this manner, possibly thousands of instances belonging to different solutions may be added to the configuration and assigned to the same monitoring cluster.

For more global monitoring, to solve the problem of monitoring at enterprise scale, which configuration gets assigned to which regional cluster may be determined. Associated complexity may be manageable because the number of regional monitoring clusters may be limited. It is then possible to define configuration(s) that apply to all monitoring clusters (e.g., ping all hosts on the local subnet), or collect metrics about a global service. Such configuration(s) would only have to be specified once. Similarly, configurations may be templated based on regional properties.

Described techniques provide cluster auto scaling, since a configuration is assigned to a cluster and not to an individual agent. As a result, the agents can be treated collectively, and a capacity of the agents may be scaled up automatically. As a result, for example, administrators may only have to set up regional autoscalers, and the autoscalers may then expand the cluster size based on typical autoscaler metrics.

As described herein, in many modern environments, such as virtualized or cloud environments, in which several types of infrastructure or applications are provisioned, entities for monitoring may increase exponentially. Described techniques provide a mechanism for distributing monitoring load amongst multiple agents or agent pods. In an environment where agent containers and/or pods are dynamically increased or decreased, the underlying infrastructure may be of the same or similar configurations, which may increase a need for load balancing.

In example implementations, the load may be identified by using a count of solutions being monitored by each agent and/or pod and load per solution by identifying the number of attributes that need to be monitored for each instance of the solution. Load identification may thus be done by creating a hierarchy of the entities and attributes count received as part of discovery and identifying the need to increase or decrease the number of pods based on existing information and/or model with already obtained results.

Since the information of the solutions and their entities hierarchy and attribute counts are available on the server, such information may be used to split the hierarchy on the basis of solutions or attributes that are monitored. Monitoring configurations for each solution or hierarchy may then be sent to different agent pods, which may in turn discover the entity objects and collect metrics for those entities.

Continuous identification may be used to validate whether further splitting is needed. For example, as the monitoring continues, new entities may be added or removed from the hierarchy, as more instances are provisioned or de-provisioned, based on monitoring of pods and identification of modifications in entity count. The monitoring of pods may be done on the basis of custom metrics, such as, e.g., collection capacity and collection lag.

Logical splitting of instances may happen automatically at a configuration system, e.g., based on the load on the server, and may be applied to agents. This approach may thus eventually distribute a load in a horizontal manner between agent pods instead of vertical scaling of individual agent pods, while keeping the monitoring of the environment uninterrupted.

The challenge of scale for monitoring containerized workloads may be understood when considering a typical enterprise, in which many clouds are present, each cloud has many clusters, and each cluster has many services and/or containers. Conventional solutions in such scenarios, and other scenarios, are static and may require configuration for each agent. When scale becomes a challenge, manual rebalancing may be performed, but with the limitations of the conventional monitoring solution.

For example, conventional approaches may manually increase monitoring resources so that a user would need knowledge of the solutions being monitored. In dynamic environments, this becomes very difficult to keep pace with entities' lifecycles. For example, resources such as CPU and memory may be increased. To keep pace, important entities may be identified, and entities being monitored may be limited on the basis of the resources provided to the agent. In other examples, a sampling rate may be adjusted, e.g., having a few entities being monitored every five minutes, while others are limited to six or seven minutes.

In contrast, described techniques are adaptive as they dynamically identify the need for auto-scaling and auto-splitting. Described techniques are dynamic as entity discovery happens on all agents and the decision of allowing to collect metrics on the agent pod is taken on the server. Described techniques combine multiple data collection pods to create one large data collection agent for collecting metrics for a single solution having large number of entities. Described techniques identify changes in hierarchy when new entities are added or removed dynamically.

Implementations of the various techniques described herein may be implemented in digital electronic circuitry, or in computer hardware, firmware, software, or in combinations of them. Implementations may be implemented as a computer program product, i.e., a computer program tangibly embodied in an information carrier, e.g., in a machine-readable storage device, for execution by, or to control the operation of, data processing apparatuses, e.g., a programmable processor, a computer, a server, multiple computers or servers, or other kind(s) of digital computer(s). A computer program, such as the computer program(s) described above, can be written in any form of programming language, including compiled or interpreted languages, and can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Method steps may be performed by one or more programmable processors executing a computer program to perform functions by operating on input data and generating output. Method steps also may be performed by, and an apparatus may be implemented as, special purpose logic circuitry, e.g., an FPGA (field programmable gate array) or an ASIC (application-specific integrated circuit).

Processors suitable for the execution of a computer program include, by way of example, both general and special purpose microprocessors and any one or more processors of any kind of digital computer. Generally, a processor will receive instructions and data from a read-only memory or a random access memory or both. Elements of a computer may include at least one processor for executing instructions and one or more memory devices for storing instructions and data. Generally, a computer also may include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory may be supplemented by or incorporated in special purpose logic circuitry.

To provide for interaction with a user, implementations may be implemented on a computer having a display device, e.g., a cathode ray tube (CRT) or liquid crystal display (LCD) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Implementations may be implemented in a computing system that includes a back-end component, e.g., as a data server, or that includes a middleware component, e.g., an application server, or that includes a front-end component, e.g., a client computer having a graphical user interface or a Web browser through which a user can interact with an implementation, or any combination of such back-end, middleware, or front-end components. Components may be interconnected by any form or medium of digital data communication, e.g., a communication network. Examples of communication networks include a local area network (LAN) and a wide area network (WAN), e.g., the Internet.

While certain features of the described implementations have been illustrated as described herein, many modifications, substitutions, changes, and equivalents will now occur to those skilled in the art. It is, therefore, to be understood that the appended claims are intended to cover all such modifications and changes as fall within the scope of the embodiments.

What is claimed is:

1. A computer program product, the computer program product being tangibly embodied on a non-transitory computer-readable storage medium and comprising instructions that, when executed by at least one computing device, are configured to cause the at least one computing device to:
receive a first authorization request from a first monitoring agent for first parameter collection for a first discovered instance within a monitored system;
receive a second authorization request from the first monitoring agent for second parameter collection for a second discovered instance within the monitored system;
receive a third authorization request from a second monitoring agent for the first parameter collection for the first discovered instance within the monitored system;
receive a fourth authorization request from the second monitoring agent for the second parameter collection for the second discovered instance within the monitored system;
approve the first authorization request to authorize the first monitoring agent to proceed with the first parameter collection for the first discovered instance; and
approve the fourth authorization request to authorize the second monitoring agent to proceed with the second parameter collection for the second discovered instance.

2. The computer program product of claim 1, wherein the first authorization request and the second authorization request include a first current monitoring load of the first monitoring agent, and the third authorization request and the fourth authorization request include a second current monitoring load of the second monitoring agent.

3. The computer program product of claim 1, wherein the first authorization request and the second authorization request include a first projected monitoring load of the first monitoring agent in performing the first parameter collection and a second projected monitoring load of the first monitoring agent in performing the second parameter collection.

4. The computer program product of claim 1, wherein the instructions, when executed, are further configured to cause the at least one computing device to:
receive a first topology from the first monitoring agent that includes the first discovered instance and the second discovered instance;
receive a second topology from the second monitoring agent that includes the first discovered instance and the second discovered instance; and
determine an aggregated topology using the first topology and the second topology.

5. The computer program product of claim 1, wherein the instructions, when executed, are further configured to cause the at least one computing device to:
approve the first authorization request and the fourth authorization request based on a first current monitoring capacity of the first monitoring agent and a second current monitoring capacity of the second monitoring agent, respectively.

6. The computer program product of claim 1, wherein the instructions, when executed, are further configured to cause the at least one computing device to:
approve the first authorization request and the fourth authorization request based on a distribution algorithm that inputs current monitoring loads of the first monitoring agent and of the second monitoring agent, projected monitoring loads associated with the first authorization request and the fourth authorization request, and on available capacities of the first monitoring agent and of the second monitoring agent.

7. The computer program product of claim 6, wherein the distribution algorithm includes a first fit distribution algorithm.

8. The computer program product of claim 1, wherein the instructions, when executed, are further configured to cause the at least one computing device to:
deny the second authorization request to prevent the first monitoring agent from proceeding with the second parameter collection for the second discovered instance; and
deny the third authorization request to prevent the second monitoring agent from proceeding with the first parameter collection for the first discovered instance.

9. The computer program product of claim 1, wherein the instructions, when executed, are further configured to cause the at least one computing device to:
receive, following approval of the first authorization request and of the fourth authorization request, an updated monitoring load report from the first monitoring agent and the second monitoring agent; and
reassign the second parameter collection for the second discovered instance from the second monitoring agent to the first monitoring agent, based on the updated monitoring load report.

10. The computer program product of claim 1, wherein the instructions, when executed, are further configured to cause the at least one computing device to:
detect that the second monitoring agent has been removed; and
reassign the second parameter collection for the second discovered instance from the second monitoring agent to the first monitoring agent.

11. A computer-implemented method, the method comprising:
receiving a first authorization request from a first monitoring agent for first parameter collection for a first discovered instance within a monitored system;
receiving a second authorization request from the first monitoring agent for second parameter collection for a second discovered instance within the monitored system;
receiving a third authorization request from a second monitoring agent for the first parameter collection for the first discovered instance within the monitored system;
receiving a fourth authorization request from the second monitoring agent for the second parameter collection for the second discovered instance within the monitored system;
approving the first authorization request to authorize the first monitoring agent to proceed with the first parameter collection for the first discovered instance; and
approving the fourth authorization request to authorize the second monitoring agent to proceed with the second parameter collection for the second discovered instance.

12. The method of claim 11, wherein the first authorization request and the second authorization request include a first current monitoring load of the first monitoring agent, and the third authorization request and the fourth authorization request include a second current monitoring load of the second monitoring agent.

13. The method of claim 11, wherein the first authorization request and the second authorization request include a first projected monitoring load of the first monitoring agent in performing the first parameter collection and a second projected monitoring load of the first monitoring agent in performing the second parameter collection.

14. The method of claim 11, further comprising:
receiving a first topology from the first monitoring agent that includes the first discovered instance and the second discovered instance;
receiving a second topology from the second monitoring agent that includes the first discovered instance and the second discovered instance; and
determining an aggregated topology using the first topology and the second topology.

15. The method of claim 11, further comprising:
approving the first authorization request and the fourth authorization request based on a first current monitoring capacity of the first monitoring agent and a second current monitoring capacity of the second monitoring agent, respectively.

16. The method of claim 11, further comprising:
denying the second authorization request to prevent the first monitoring agent from proceeding with the second parameter collection for the second discovered instance; and
denying the third authorization request to prevent the second monitoring agent from proceeding with the first parameter collection for the first discovered instance.

17. A system comprising:
at least one memory including instructions; and
at least one processor that is operably coupled to the at least one memory and that is arranged and configured to execute instructions that, when executed, cause the at least one processor to:
receive a first authorization request from a first monitoring agent for first parameter collection for a first discovered instance within a monitored system;
receive a second authorization request from the first monitoring agent for second parameter collection for a second discovered instance within the monitored system;
receive a third authorization request from a second monitoring agent for the first parameter collection for the first discovered instance within the monitored system;
receive a fourth authorization request from the second monitoring agent for the second parameter collection for the second discovered instance within the monitored system;
approve the first authorization request to authorize the first monitoring agent to proceed with the first parameter collection for the first discovered instance; and
approve the fourth authorization request to authorize the second monitoring agent to proceed with the second parameter collection for the second discovered instance.

18. The system of claim 17, wherein the first authorization request and the second authorization request include a first current monitoring load of the first monitoring agent, and the third authorization request and the fourth authorization request include a second current monitoring load of the second monitoring agent.

19. The system of claim 17, wherein the first authorization request and the second authorization request include a first projected monitoring load of the first monitoring agent in performing the first parameter collection and a second projected monitoring load of the first monitoring agent in performing the second parameter collection.

20. The system of claim 17, wherein the instructions, when executed, are further configured to cause the at least one processor to:
deny the second authorization request to prevent the first monitoring agent from proceeding with the second parameter collection for the second discovered instance; and
deny the third authorization request to prevent the second monitoring agent from proceeding with the first parameter collection for the first discovered instance.
